(19) United States
(12) Patent Application Publication
(10) Pub. No.: US 2015/0091925 A1
(43) Pub. Date: Apr. 2, 2015

(54) METHOD AND APPARATUS FOR CONVERTING DATA

(71) Applicant: Samsung Electronics Co., Ltd., Suwon-si (KR)

(72) Inventors: Chae-seok IM, Yongin-si (KR); Min-young SON, Hwaseong-si (KR); Seong-gun KIM, Yongin-si (KR)

(73) Assignee: Samsung Electronics Co., Ltd., Suwon-si (KR)

(21) Appl. No.: 14/491,122

(22) Filed: Sep. 19, 2014

(30) Foreign Application Priority Data
Sep. 27, 2013 (KR) 10-2013-0115719

(51) Int. Cl. G09G 5/00; G06T 1/20

(52) U.S. Cl. CPC G09G 5/001; G06T 1/20; G09G 2360/18
USPC 345/545

(57) ABSTRACT

Methods and apparatuses are provided for converting data efficiently and for converting input data by automatically calculating a size of an input buffer in accordance with information regarding input data when the input data is converted. The method of converting data may include receiving size information of an output buffer, receiving range information of input data used to calculate output data corresponding to each point within the output buffer, calculating size information of an input buffer using the size information of the output buffer and the range information of the input data, loading the input data using the size information of the input buffer, and calculating the output data using the loaded input data.

### CROSS-REFERENCE TO RELATED APPLICATIONS

This application claims the priority benefit of Korean Patent Application No. 10-2013-0115719, filed on Sep. 27, 2013, in the Korean Intellectual Property Office, the disclosure of which is incorporated herein in its entirety by reference.

### BACKGROUND

1. Field

One or more embodiments relate to methods and apparatuses for converting data efficiently and for converting input data by automatically calculating a size of an input buffer in accordance with information regarding input data when the input data is converted.

2. Description of the Related Art

In various parallel processing programs, filtering programs used in image processing, or the like, a plurality of pieces of input data may be used to acquire one piece of output data. For example, in order to acquire output data of one point, a bilateral filtering program may use both input data corresponding to the point and input data corresponding to neighboring points.

Particularly, output data of a pixel may be acquired using input data of all pixels within a range from the pixel. For example, output data of a point (x, y) may be acquired using input data within a rectangle with vertexes (x−i, y−m), (x+j, y−m), (x−i, y+n), and (x+j, y+n).

In addition, a range of input data used to calculate output data of one point may be similar to a range of input data required to calculate output data of another point adjacent to the one point. In detail, a case in which output data is acquired from point (x, y), and then output data is acquired from point (x+1, y) will be described.

For example, output data of the point (x, y) may be acquired using all input data within a rectangle with vertexes (x−i, y−m), (x+j, y−m), (x−i, y+n), and (x+j, y+n). In this case, in order to acquire output data of the point (x+1, y), all input data within a rectangle with vertexes (x+1−i, y−m), (x+1+j, y−m), (x+1−i, y+n), and (x+1+j, y+n) may be used.

Thus, input data of the same point may be used plural times while calculating output data corresponding to each of the consecutive points. As a result, when input data within a predetermined range is loaded into a local memory, such as a cache, of a core of a processor in advance, and output data is calculated using the data stored in the local memory, total calculation time of the output data may be reduced.

### SUMMARY

In an aspect of one or more embodiments, there are provided methods and apparatuses for converting data automatically and for calculating a size of an input buffer in accordance with information regarding input data when converting the input data.

In an aspect of one or more embodiments, there are provided methods and apparatuses for converting data and for automatically calculating size information of an input buffer using information regarding a range of input data required to calculate output data.

In an aspect of one or more embodiments, there are provided methods and apparatuses for converting data and for automatically calculating size information of an input buffer using size information of an output buffer and range information of input data.

In an aspect of one or more embodiments, there are provided methods and apparatuses for converting data efficiently and for converting input data by converting the input data into output data using automatically calculated size information of an input buffer.

In an aspect of one or more embodiments, there is provided a method of converting data which includes receiving size information of an output buffer, receiving range information of input data used to calculate output data corresponding to each point within the output buffer, calculating size information of an input buffer using the size information of the output buffer and the range information of the input data, loading the input data using the size information of the input buffer, and calculating the output data using the loaded input data.

The range information may include a function regarding coordinate components of a point within the output buffer.

The range information may have an upper limit and a lower limit, wherein the upper limit and the lower limit are functions regarding coordinate components of a point within the output buffer.

The calculating of the size information of the input buffer may include calculating the number of the output data used to calculate the output data corresponding to all points within the output buffer using the size information of the output buffer and the range information of the input data.

The loading of the input data may include creating the input buffer using the size information of the input buffer, and loading the input data, the number of which corresponds to the size information of the input buffer.

The loading of the input data may include determining a location of the input data using a location corresponding to the output buffer and the range information, and loading the input data using the determined location of the input data.

The calculating of the output data may include storing the calculated output data in the output buffer.

The method may further include storing contents of the output buffer in a memory, and repeating the loading of the input data to the storing the contents of the output buffer in the memory, after the calculating of the output data.

In an aspect one or more embodiments, there is provided a method of converting data which includes receiving range information of input data used to calculate output data, calculating size information of an input buffer using the range information of the input data, loading the input data using the size information of the input buffer, and calculating the output data using the loaded input data.

The loading of the input data may include creating the input buffer using the size information of the input buffer, and loading the input data, the number of which corresponds to the size information of the input buffer.

The method may further include repeating the loading of the input data to the calculating of the output data after the calculating of the output data.

In an aspect of one or more embodiments, there is provided an apparatus for converting data which includes an information receiving unit to receive size information of an output buffer and receive range information of input data used to calculate output data corresponding to each of the points within the output buffer, an input buffer size information calculation unit to calculate size information of the input buffer using the size information of the output buffer and the range information of the input data, and an output data calculation unit to load the input data using the size information of the input buffer and calculate the output data using the loaded input data.

The range information may include a function regarding coordinate components of a point within the output buffer.

The range information may have an upper limit and a lower limit, wherein the upper limit and the lower limit are functions regarding coordinate components of a point within the output buffer.

The input buffer size information calculation unit may calculate the number of the input data used to calculate output data corresponding to all points within the output buffer using the size information of the output buffer and the range information of the input data.

The output data calculation unit may create the input buffer using the size information of the input buffer and load the input data the number of which corresponds to the size information of the input buffer.

The output data calculation unit may determine a location of the input data using a location corresponding to the output buffer and the range information, and load the input data using the determined location of the input data.

The output data calculation unit may store the calculated output data in the output buffer.

According to an aspect of one or more embodiments, there is provided at least one non-transitory computer readable medium storing computer readable instructions when executed to implement methods of one or more embodiments.

### BRIEF DESCRIPTION OF THE DRAWINGS

These and/or other aspects will become apparent and more readily appreciated from the following description of embodiments, taken in conjunction with the accompanying drawings in which:

FIG. 1 is a flowchart of a process of converting data according to an embodiment;

FIG. 2 is a diagram for describing a method of calculating output data using input data within a particular range according to an embodiment;

FIG. 3 is a diagram for describing a method of calculating output data using an input buffer and an output buffer according to an embodiment; and

FIG. 4 is a block diagram of a data converting apparatus according to an embodiment.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects of the present description. Expressions such as “at least one of,” when preceding a list of elements, modify the entire list of elements and do not modify the individual elements of the list.

It will be understood that although the terms “first” and “second” are used only to describe various components, these components should not be limited by these terms. These terms may be used to distinguish one of the components from another component. Thus, throughout the specification, a first component may indicate a second component without conflicting.

Throughout the specification, a singular form may include plural forms, unless there is a particular description contrary thereto. Throughout the specification, a singular form may include plural forms, unless there is a particular description contrary thereto. Also, terms such as “comprise” or “comprising” are used to specify existence of a recited form, a number, a process, an operations, a component, and/or groups thereof, not excluding the existence of one or more other recited forms, one or more other numbers, one or more other processes, one or more other operations, one or more other components and/or groups thereof.

Unless expressly described otherwise, all terms including descriptive or technical terms which are used herein should be construed as having meanings that are understood by one of ordinary skill in the art. Also, terms that are defined in a general dictionary and that are used in the following description should be construed as having meanings that are equivalent to meanings used in the related description, and unless expressly described otherwise herein, the terms should not be construed as being ideal or excessively formal.

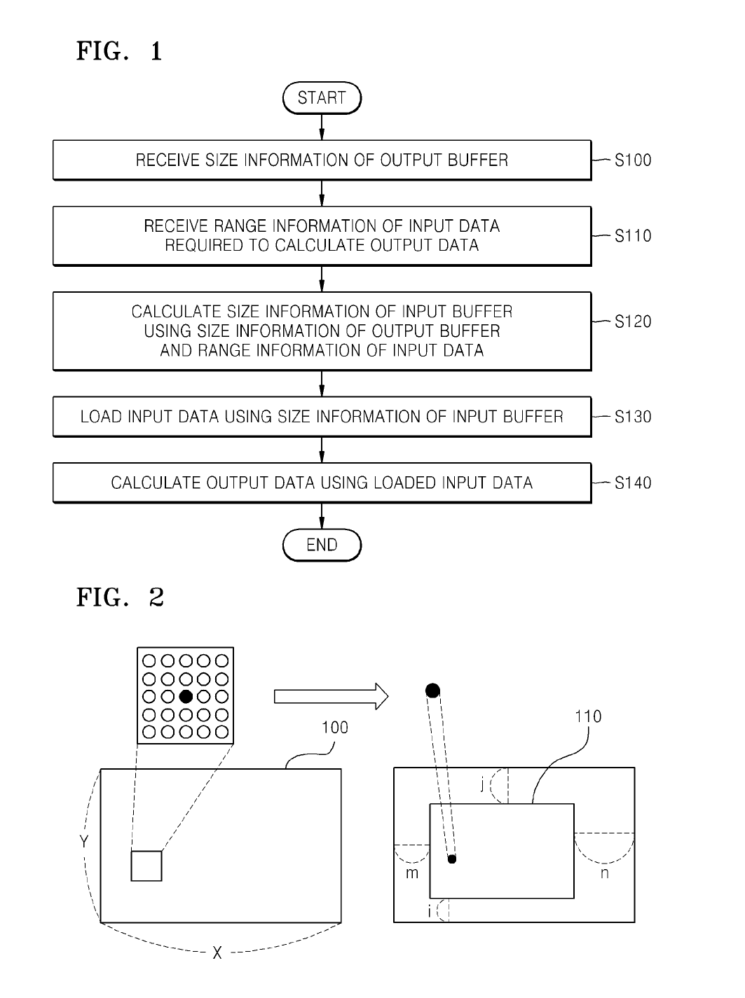

Hereinafter, a method of converting data and a data converting apparatus 200 according to embodiments will be described in detail with reference to FIGS. 1 to 4.

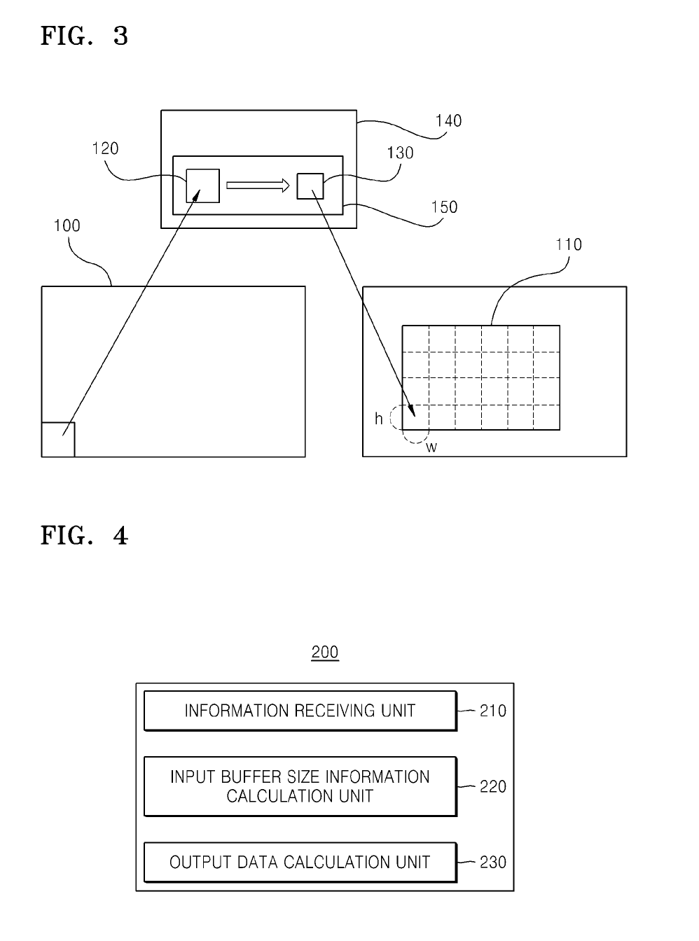

FIG. 1 is a flowchart of a process of converting data according to an embodiment. Referring to FIG. 1, a method of converting according to an embodiment includes receiving size information (S100) of an output buffer. The receiving of the size information of the output buffer (S100) will be described in more detail with reference to FIGS. 2 and 3.

FIG. 2 is a diagram for describing a method of calculating output data using input data within a particular range according to an embodiment.

Referring to FIG. 2, the output data may be calculated using the entire input data 100 including at least one piece of input data arranged in a rectangular shape having a width of X and a height of Y. In other words, the entire input data 100 may include at least one piece of input data which are two-dimensionally arranged. X pieces of input data may be contained in one row. Y pieces of input data may be contained in one column.

One piece of output data may be calculated using input data within a particular range contained in the entire input data 100. As illustrated in FIG. 2, one piece of output data may be calculated using a total of 25 pieces of input data within a square with vertexes (0, 0), (4, 0), (0, 4), and (4, 4). The calculated output data may correspond to a central point of the square. In other words, the calculated output data may correspond to point (2, 2).

In addition, the process of calculating output data may be repeated as described above until all output data corresponding to points within the particular range is calculated. Referring to FIG. 2, the process may be repeated until output data corresponding to all points within a rectangle with vertexes (2, 2), (X−1−2, 2), (2, Y−1−2), and (X−1−2, Y-1-2) is calculated. In other words, the entire output data 110 arranged in a rectangular shape having a width of X−2−2 and a height of Y−2−2 may be calculated.

In an embodiment, the output data corresponding to a particular point may be calculated using input data of all points within a predetermined distance from the particular point. Referring to FIG. 2, output data corresponding to point (x, y) may be acquired using input data within a rectangle with vertexes (x−2, y−2), (x+2, y−2), (x−2, y+2), and (x+2, y+2).

Output data corresponding to the point (x, y) may be calculated using input data within a rectangle with vertexes (x−i, y−m), (x+j, y−m), (x−i, y+n), and (x+j, y+n). When the entire input data 100 having a width of X and a height Y is used, output data corresponding to each of the points within a rectangle with vertexes (i, m), (X−1−j, m), (i, Y−1−n), and (X−1−j, Y-1-n) may be calculated.

FIG. 3 is a diagram for describing a method of calculating output data using an input buffer 120 and an output buffer 130 according to an embodiment.

A range of input data used to calculate output data of one point may be similar to a range of input data required to calculate output data of another point adjacent to the one point. An embodiment in which output data is acquired from point (x, y), and then output data is acquired from point (x+1, y) will be described.

For example, the output data of the point (x, y) may be acquired using input data within a rectangle with vertexes (x−i, y−m), (x+j, y−m), (x−i, y+n), and (x+j, y+n). In an embodiment, the output data of the point (x+1, y) may be acquired using input data within a rectangle with vertexes (x+1−i, y−m), (x+1 +j, y−m), (x+1−i, y+n), and (x+1+j, y+n).

Thus, input data of the same point may be used plural times while calculating output data corresponding to each of consecutive points. Accordingly, input data within a particular range among the entire input data 100 stored in a shared memory may be loaded into a local memory 150, e.g., a cache, of a core 140 of a processor in advance. When output data is calculated using the data stored in the local memory 150, total calculation time of output data may be reduced.

However, the size of the entire input data 100 is generally greater than the size of the local memory 150. Thus, it may be impossible to load the entire input data 100 into the local memory 150. Thus, the entire input data 100 may be partitioned into sections having a particular size. Thus, the partitioned input data may be sequentially loaded into the local memory 150. Input data of one section may be loaded into an input buffer 120 of the local memory 150.

When the partitioned input data is loaded, output data partitioned similarly to the method as illustrated in FIG. 2 may be calculated using the partitioned input data. For example, it is assumed that the partitioned input data includes input data arranged in a square having a width of 8 and a height of 8. In addition, it is assumed that output data corresponding to a particular point is calculated using input data within a square having a width of 5 and a height of 5 in which the particular point is the center. In this regard, partitioned output data including output data arranged in a square having a width of 4 and a height of 4 may be calculated from the partitioned input data. The partitioned output data may be stored in an output buffer 130 of the local memory 150.

Each section of the partitioned output data converted from each section of the partitioned input data may be sequentially stored in the shared memory. That is, the entire output data 110 stored in the shared memory may include at least one section of the partitioned output data. Each section of the partitioned output data may respectively be converted from each section of the partitioned input data.

A user may determine the size of the output buffer 130 to convert input data into output data. As the size of the output buffer 130 increases, the size of the input buffer 120 may increase. In addition, as the size of the input buffer 120 increases, the number of loading the partitioned input data may decrease. However, since the size of the local memory 150 is limited, the size of the output buffer 130 cannot be increased indefinitely. Accordingly, the output buffer 130 may have an appropriate size at user's desire.

According to the method of converting data, in the receiving of the size information of the output buffer (S100), size information of the particular output buffer 130 as described above may be received.

Referring back to FIG. 1, range information of input data required to calculate output data corresponding to each of the points within the output buffer 130 may be received (S110). The user may determine the range information of input data required to calculate output data corresponding to each of the points within the output buffer 130.

For example, referring to FIGS. 2 and 3, the range of input data required to calculate output data corresponding to one point within the output buffer 130 may include all input data within a square having a width of 5 and a height of 5 in which the point is the center.

For example, determining a range of input data required to calculate output data corresponding to a k-dimensional point P (k<=1) will be described. The point P may be represented by a vector having k elements, for example, (p1, p2, . . . , and pk). In other words, the point P may be represented as coordinates (p1, p2, . . . , and pk).

The range of input data required to calculate output data corresponding to the point P may be expressed as a function of coordinate components of the point P. In addition, the required range of input data may have an upper limit and a lower limit. Thus, the upper limit and the lower limit contained in the required range of the input data may be expressed as a function of each of the elements of the vector indicating the point P.

For example, the range of input data required to calculate output data corresponding to the point P may have an upper limit vector Pmax and a lower limit vector Pmin. Pmax may be represented as a vector having k elements of (f(p1), f(p2), . . . , and f(pk)). Function f(p) may be a function for calculating the upper limit corresponding to element p using the element p. Pmin may be represented as a vector having k elements of (g(p1), g(p2), . . . , and g(pk)). Function g(p) may be a function for calculating the lower limit corresponding to the element p using the element p.

In order to calculate output data corresponding to the point P, input data of all points within a k-dimensional range based on each of the elements of the upper limit vector Pmax and the lower limit may be used. For example, input data of all points within a space with vertexes of Pmax and Pmin may be used. For example, input data of all points between g(p1) and f(p1), between g(p2) and f(p2), . . . , and between g(pk) and f(pk) may be used.

Referring to FIG. 2, since the point P is located in a two-dimensional space, the point P may be represented by a vector including two elements such as (x, y). In addition, Pmax may be represented by a vector including two functions such as (x+2, y+2). The Pmin may also be represented by a vector including two functions such as (x−2, y−2). Thus, output data corresponding to the point P may be calculated using input data of all points between (x−2) and (x+2) and between (y−2) and (y+2). In other words, input data of all points within a square having a 5×5 size in which the point (x, y) serves as the center of the square may be used.

For example, output data of the point P is acquired using input data within a rectangle with vertexes (x−i, y−m), (x+j, y−m), (x−i, y+n), and (x+j, y+n). In an embodiment, Pmax may be represented by a vector including two functions such as (x+j, y+n). The Pmin may also be represented by a vector including two functions such as (x−i, y−m).

According to the method of converting data, in the receiving of the range information of input data required to calculate output data (S110), information regarding the Pmax and Pmin may be received.

Referring back to FIG. 1, size information of the input buffer 120 may be acquired using the size information of the output buffer 130 and the range information of the input data (S120). For example, as described above, Pmax is represented by a vector including k elements such as (f(p1), f(p2), . . . , and f(pk)), and Pmin is represented by a vector including k elements such as (g(p1), g(p2), . . . , and g(pk)).

In an embodiment, in order to calculate output data corresponding to one point P, the number of used input data of points is {f(p1)−g(p1)+1}*{f(p2)−g(p2)+1}* . . . *{f(pk)−g(pk)+1}. When the output buffer 130 has a k-dimensional space and a size of o1*o2* . . . * ok, output data corresponding to all points of the output buffer 130 may be calculated using {f(p1)−g(p1)+1+o1}*{f(p2)−g(p2)+1+o2}* . . . *{f(pk)−g(pk)+ok} pieces of input data.

For example, referring to FIGS. 2 and 3, the output buffer 130 may have a width of w and a height of h. In this regard, output data corresponding to all points of the output buffer 130 may be calculated using {(x+2)−(x−2)+1+w}*{(y+2)−(y−2)+1+h} pieces of input data.

For example, output data of the point P may be acquired using input data within a rectangle with vertexes (x−i, y−m), (x+j, y−m), (x−i, y+n), and (x+j, y+n). In an embodiment, output data corresponding to all points of the output buffer 130 having a width of w and a height of h may be calculated using {(x+j)−(x−i)+1+w}*{(y+n)−(y−m)+1+h} pieces of input data.

Thus, in the calculating of the size information of the input buffer 120 (S120), the number of input data used to calculate output data may be calculated using the size information of the output buffer 130 and the range information of the input data. The number of calculated input data may be identical to the size of the input buffer 120. Accordingly, the size information of the input buffer 120 may be calculated.

Referring back to FIG. 1, the input data is loaded using the size information of the input buffer 120 (S130). The input buffer 120 may be created using the size information of the input buffer 120. In addition, input data corresponding to the calculated size of the input buffer 120 may be copied into the input buffer 120 from the shared memory.

A section of the entire input data 100 to be loaded may be determined using the received range information of the input data required to calculate output data. In addition, a location of input data to be loaded may correspond to a location where contents of the current output buffer 130 will be stored among the entire output data 110. In other words, the location of input data to be loaded may be determined using a location corresponding to the output buffer 130 and range information of the input data required to calculate output data.

For example, it is assumed that the output buffer 130 corresponds to a rectangle with vertexes (x, y), (x+w−1, y), (x, y+h−1), and (x+w−1, y+h−1). In other words, it is assumed that contents of the current output buffer 130 will be stored in a portion corresponding to a rectangle with vertexes (x, y), (x+w−1, y), (x, y+h−1), and (x+w−1, y+h−1). It is also assumed that input data within a rectangle with vertexes (x−i, y−m), (x+j, y−m), (x−i, y+n), and (x+j, y+n) is used to calculate output data corresponding to the point (x, y).

In an embodiment, output data corresponding to all points of the output buffer 130 having a width of w and a height of h may be calculated using {(x+j)−(x−i)+1+w}*{(y+n)−(y−m)+1+h} pieces of input data. In addition, input data of points within a rectangle with vertexes (x−i, y−m), (x+w+j−1, y−m), (x−i, y+h+n−1), and (x+w+j−1, y+h+n−1) may be copied to the input buffer 120.

Referring back to FIG. 1, the output data may be calculated using the loaded input data (S140). For example, as illustrated in FIG. 2, output data may be calculated using input data loaded into the input buffer 120. The calculated output data may be stored in the output buffer 130. In addition, when output data corresponding to all points contained in the output buffer 130 is calculated, out data stored in the output buffer 130 may be copied to the shared memory.

In addition, the loading of input data (S130) to the calculating of output data (S140) may be repeated until the entire output data 110 is calculated. For example, after calculating output data of all points within the rectangle with vertexes (x, y), (x+w−1, y), (x, y+h−1), and (x+w−1, y+h−1), the output buffer 130 may correspond to a rectangle with vertexes (x+w, y), (x+2w−1, y), (x+w, y+h−1), and (x+2w−1, y+h−1). Alternatively, the output buffer 130 may correspond to a rectangle with vertexes (x, y+h), (x+w−1, y+h), (x, y+2h−1), and (x+w−1, y+2h−1).

FIG. 4 is a block diagram of a data converting apparatus 200 according to an embodiment. Referring to FIG. 4, the data converting apparatus 200 may include an information receiving unit (information receiver) 210, an input buffer size information calculation unit (input buffer size information calculator) 220, and an output data calculation unit (output data calculator) 230.

The information receiving unit 210 may receive size information of the output buffer 130. The information receiving unit 210 may receive range information of input data required to calculate output data corresponding to each of the points of the output buffer 130. Descriptions regarding the information receiving unit 210 correspond to those of the receiving of the size information of the output buffer (S100) and the receiving of the required range information of the input data therefore (S110), and thus detailed descriptions thereof will not be repeated.

The input buffer size information calculation unit 20 may calculate size information of the input buffer 120 using the size information of the output buffer 130 and the range information of the input data. Since detailed descriptions regarding the input buffer size information calculation unit 220 correspond to those of the calculating of the size information of the input buffer 120 (S120) above, the detailed descriptions thereof will not be repeated.

The output data calculation unit 230 may load the input data using the size information of the input buffer 120. In addition, the output data calculation unit 230 may calculate the output data using the loaded input data. Since detailed description regarding the output data calculation unit 230 correspond to those of the loading of input data (S130) and those of the calculating of output data (S140), the detailed descriptions thereof will not be repeated.

According to one or more embodiments as described above, the size of the input buffer may automatically be calculated according to information regarding input data when the input data is converted. In addition, the size information of the input buffer may automatically be calculated using the range information of input data required to calculate output data. Furthermore, the size information of the input buffer may automatically be calculated using the size information of the output buffer and the range information of the input data. In addition, input data may efficiently be converted by converting the input data into output data using the automatically calculated size information of the input buffer.

As described above, according to one or more embodiments, the size of the input buffer may automatically be calculated according to information regarding input data when the input data is converted.

According to one or more embodiments, the size information of the input buffer may automatically be calculated using the range information of input data required to calculate output data.

According to one or more embodiments, the size information of the input buffer may automatically be calculated using the size information of the output buffer and the range information of input data.

According to one or more embodiments, input data may efficiently be converted by converting input data into output data using the automatically calculated size information of the output buffer.

Processes, functions, methods, and/or software in apparatuses described herein may be recorded, stored, or fixed in one or more non-transitory computer-readable storage media (computer readable recording medium) that includes program instructions (computer readable instructions) to be implemented by a computer to cause one or more processors to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions may be executed by one or more processors. The described hardware devices may be configured to act as one or more software modules that are recorded, stored, or fixed in one or more computer-readable storage media, in order to perform the operations and methods described above, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the present disclosure as defined by the following claims and their equivalents.

What is claimed is:

1. A method of converting data, the method comprising:
receiving size information of an output buffer;
receiving range information of input data used to calculate output data corresponding to each point within the output buffer;
calculating, using at least one processor, size information of an input buffer using the size information of the output buffer and the range information of the input data;
loading the input data using the size information of the input buffer; and
calculating the output data using the loaded input data.

2. The method of claim 1, wherein the range information comprises a function with coordinate components of a point within the output buffer.

3. The method of claim 1, wherein:
the range information has an upper limit and a lower limit, and
the upper limit and the lower limit are functions with coordinate components of a point within the output buffer.

4. The method of claim 1, wherein the calculating of the size information of the input buffer comprises calculating the number of the output data used to calculate the output data corresponding to all points within the output buffer using the size information of the output buffer and the range information of the input data.

5. The method of claim 1, wherein the loading of the input data comprises:
creating the input buffer using the size information of the input buffer; and
loading the input data, the number of which corresponds to the size information of the input buffer.

6. The method of claim 1, wherein the loading of the input data comprises:
determining a location of the input data using a location corresponding to the output buffer and the range information; and
loading the input data using the determined location of the input data.

7. The method of claim 1, wherein the calculating of the output data comprises:
storing the calculated output data in the output buffer.

8. The method of claim 7, further comprising:
storing contents of the output buffer in a memory; and
repeating the loading of the input data to the storing the contents of the output buffer in the memory,
after the calculating of the output data.

9. A method of converting data, the method comprising:
receiving range information of input data used to calculate output data;
calculating size information of an input buffer using the range information of the input data;
loading the input data using the size information of the input buffer; and
calculating the output data using the loaded input data.

10. The method of claim 9, wherein the loading of the input data comprises:
creating the input buffer using the size information of the input buffer; and
loading the input data, the number of which corresponds to the size information of the input buffer.

11. The method of claim 9, further comprising repeating the loading of the input data to the calculating of the output data after the calculating of the output data.

12. An apparatus for converting data comprising:
an information receiver to receive size information of an output buffer and receive range information of input data used to calculate output data corresponding to each of the points within the output buffer;
an input buffer size information calculator, which uses at least one processor, to calculate size information of the input buffer using the size information of the output buffer and the range information of the input data; and
an output data calculator to load the input data using the size information of the input buffer and calculate the output data using the loaded input data.

13. The apparatus of claim 12, wherein the range information comprises a function with coordinate components of a point within the output buffer.

14. The apparatus of claim 12, wherein:
the range information has an upper limit and a lower limit, and
the upper limit and the lower limit are functions with coordinate components of a point within the output buffer.

15. The apparatus of claim 12, wherein the input buffer size information calculator calculates the number of the input data used to calculate output data corresponding to all points within the output buffer using the size information of the output buffer and the range information of the input data.

16. The apparatus of claim 12, wherein the output data calculator creates the input buffer using the size information of the input buffer and loads the input data the number of which corresponds to the size information of the input buffer.

17. The apparatus of claim 12, wherein the output data calculator determines a location of the input data using a location corresponding to the output buffer and the range information, and loads the input data using the determined location of the input data.

18. The apparatus of claim 12, wherein the output data calculator stores the calculated output data in the output buffer.

19. At least one computer readable medium storing computer readable instructions that control at least one processor when executed to implement the method of claim 1.
